(19) United States
(12) Patent Application Publication
(10) Pub. No.: US 2015/0199692 A1
(43) Pub. Date: Jul. 16, 2015

(54) WARRANTY EXPIRY PRIOR-NOTIFICATION SYSTEM, POS TERMINAL AND METHOD FOR PRIOR-NOTIFYING WARRANTY EXPIRY

(71) Applicant: TOSHIBA TEC KABUSHIKA KAISHA, Tokyo (JP)

(72) Inventor: Kaoru Matsuhisa, Fuji Shizuoka (JP)

(21) Appl. No.: 14/590,191

(22) Filed: Jan. 6, 2015

(30) Foreign Application Priority Data
Jan. 14, 2014 (JP) 2014-004046

(51) Int. Cl. G06Q 30/00

(52) U.S. Cl. CPC G06Q 30/012

(57) ABSTRACT

A warranty expiry prior-notification system comprises a POS terminal which includes a data temporary storage section for storing data of the purchased commodity, and an approaching warranty expiration date notification section for notifying that the warranty expiration date of the commodity purchased in the past is approaching; and a server which includes a customer information management section for managing various information of a customer containing information of the commodity purchased in the past.

This application is based upon and claims the benefit of priority from Japanese Patent Application No. 2014-004046, filed Jan. 14, 2014, the entire contents of which are incorporated herein by reference.

### FIELD

Embodiments described herein relate generally to a warranty expiry prior-notification system, a POS terminal used in the warranty expiry prior-notification system, and a method for prior-notifying an expiry of warranty.

### BACKGROUND

When a commodity is purchased, a receipt on which a commodity name, an amount and the like of the purchased commodity are recorded is issued through a commodity settlement terminal such as a POS terminal and the like, and then is handed to a customer (purchaser) of the commodity. In a case in which a customer purchases, for example, an electric appliance and the like, a warranty certificate on which the year and date of purchasing the commodity is printed is also handed to the customer together with the receipt.

The customer, i.e., purchaser, keeps the warranty certificate within the warranty period, and thus after-sales service or customer support of the purchased product such as a repair covered by the warranty certificate is provided with no cost basically if a repair is required within the warranty period.

As described above, the warranty certificate is handed to the purchaser when the commodity is sold, but there is a problem that it takes time to issue the warranty certificate. Thus, it is known that the warranty certificate is formed with a non-contact medium, and information including the expiry of the warranty period of commodity is stored in this medium. However, it often happens that the purchaser forgets the expiry of the warranty period although the purchaser himself or herself has to keep the expiry of the warranty period of the purchased commodity in mind.

### BRIEF DESCRIPTION OF THE DRAWINGS

FIG. 1 is a diagram illustrating an example of the constitution of a system according, to a first embodiment;

FIG. 2 is a diagram illustrating an example of the constitution of a POS terminal of the system according to the first embodiment;

FIG. 3 is a diagram illustrating an example of the constitution of a server of the system according to the first embodiment;

FIG. 4 is a flowchart illustrating an example of a data processing of the system according to the first embodiment;

FIG. 5 is a diagram illustrating an example of items of customer data according to the first embodiment;

FIG. 6 is a diagram illustrating an example of latest items of customer data according to the first embodiment; and

FIG. 7 is a diagram illustrating an example of a display screen on which information of each commodity the warranty expiration date of which is approaching is displayed according to the first embodiment.

### DETAILED DESCRIPTION

A warranty expiry prior-notification system comprises a POS terminal, transmitting settlement completion information of a purchased commodity, which includes a data temporary storage section configured to store data of the purchased commodity, a purchased amount calculation section configured to calculate the settlement amount of the purchased commodity, and an approaching warranty expiration date notification section configured to notify that the warranty expiration date of a commodity purchased in the past is approaching; and a server which includes a customer information management section configured to manage information of a customer containing information of the commodity purchased in the past, a commodity information storage section configured to store information of commodities, a warranty period expiry notification target extraction section configured to extract, according to a predetermined extraction condition, a commodity of which the warranty expiration date is approaching within the commodities purchased by a specified customer in the past, and a notification information creation section configured to create data for outputting information of the commodity that is purchased in the past and extracted by the warranty period expiry notification target extraction section.

### A First Embodiment

Hereinafter, a warranty expiry prior-notification system according to the first embodiment is described in detail with reference to the accompanying drawings.

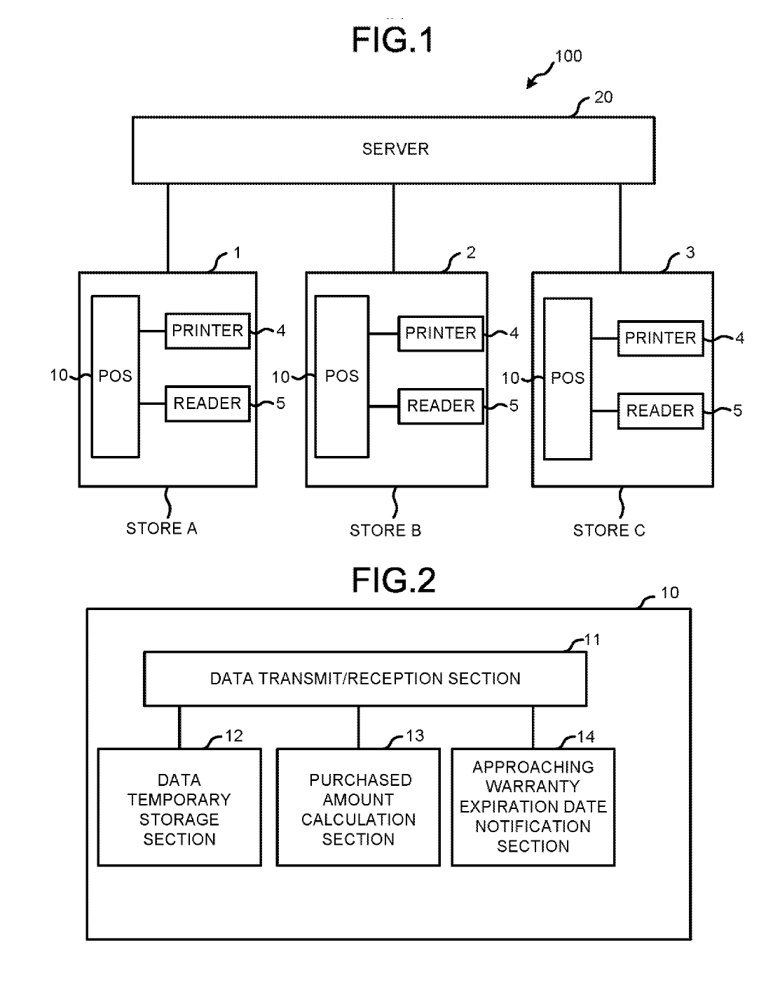

An example of the constitution of the system of the present embodiment is shown in FIG. 1.

The warranty expiry prior-notification system 100 includes, for example, a server 20 for managing customer information, various information of purchase commodities and the like, and stores A1, B2 and C3 which are respectively connected with the server 20 through a network.

The store A1 is a commodity sales store where a settlement and the like are carried out when a commodity is sold. A printer 4 and a reader 5 are connected with a POS (point of sale) terminal 10 serving as a terminal for settling sales commodities. The reader 5 is used for acquiring a commodity code such as a barcode attached to a commodity, member-ship information of a purchaser from his or her member card, and the like. The printer 4 is used for outputting a receipt while settlement of a commodity is carried out and information of a commodity of which the expiry of the warranty period is approaching.

Further, similar to the store A1, the stores B2 and C3 are also provided with the POS terminal 10, the printer 4 and the reader 5 described above.

Referring to FIG. 2, the POS terminal 10 is described in detail. The POS terminal 10 includes a data temporary storage section 12 which temporarily stores the data of a commodity brought to the checkout counter by a customer and his or her customer number, a purchased amount calculation section 13 which calculates a settlement amount of the commodity, and an approaching warranty expiration date notification section 14 which prior-notifies that there is a commodity of which the warranty expiration date is approaching. Further, a data transmit/reception section 11 is arranged to perform data transmission/reception to or from an external apparatus.

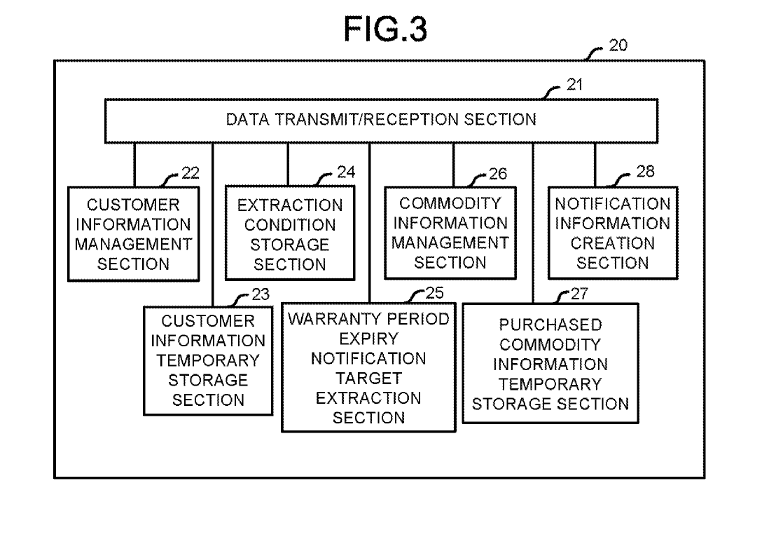

Next, the server 20 shown in FIG. 3 is described in detail. The server 20 includes a customer information management section 22 which manages customer information, a customer information temporary storage section 23 which temporarily stores customer information of a customer who purchases a commodity at this time, an extraction condition storage section 24 which stores extraction conditions for the warranty expiration date to be notified; a warranty period expiry notification target extraction section 25 which extracts a commodity (hereinafter referred to as a warranty expiry notification target commodity), subject to the prior-notification of an expiry of the warranty, which is purchased by the customer in the past, according to the information in the customer information temporary storage section 23, a commodity information management section 26 which stores information including the commodity name and the contact address of a sales commodity, a set warranty period and the like, a purchased commodity information temporary storage section 27 which temporarily stores information of the commodity purchased by the customer at this time, and a notification information creation section 28 which creates notification information for prior-notifying the customer of the warranty period expiry notification target commodity. Further, a data transmit/reception section 21 is arranged to perform data transmission/reception to or from an external apparatus.

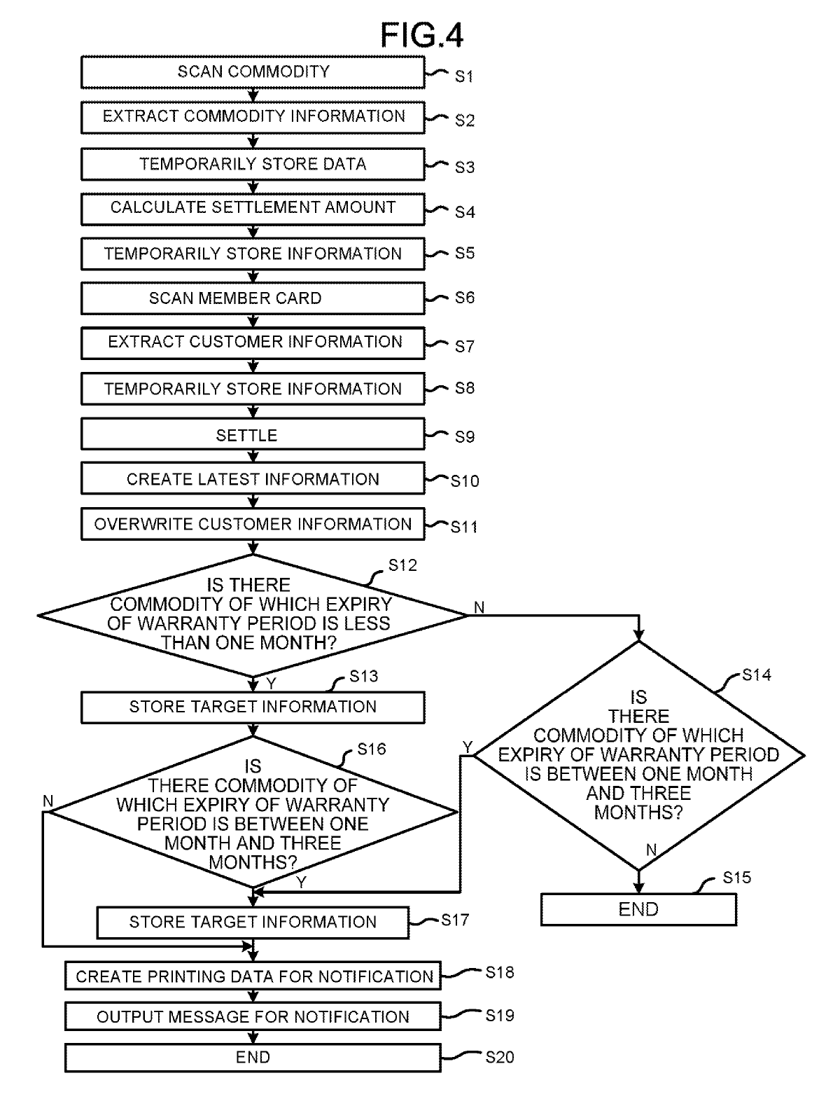

Hereinafter, a flow of a notification indicating the existence of a commodity of which the expiry of the warranty period is approaching is described with reference to FIG. 4-FIG. 7. In the present embodiment, it is assumed that the customer carries out a member registration in advance and the registered information is stored in the later-described customer information management section 22 before the customer purchases a commodity.

The customer brings a desired purchase commodity to a settlement counter. An operator (shop clerk) of, for example, the store Al scans, with the reader 5 such as an optical scanner connected with the POS terminal 10, a code symbol such as a barcode attached to the commodity to obtain the commodity code, and then transmits it to the server 20 (ACT S1).

The server 20 includes the commodity information management section 26 in which a commodity name, a unit price, a manufacturer name, a warranty period, contact information, e.g., address and telephone number, and the like are stored in association with the commodity code.

The server 20 extracts a corresponding commodity information according to the commodity code sent thereto (ACT S2), and then transmits the commodity information back to the POS terminal 10. The POS terminal 10 stores the received commodity information in the data temporary storage section 12 (ACT S3). The commodity information stored in the data temporary storage section 12 contains a commodity name, a unit price and the like. In ACT S4, the purchased amount calculation section 13 calculates the settlement amount according to the unit price stored in the data temporary storage section 12.

Further, the server 20 stores the corresponding commodity information in the purchased commodity information temporary storage section 27 (ACT S5). The commodity information stored in the purchased commodity information temporary storage section 27 contains a commodity name, a manufacturer name, a warranty period, contact information and the like.

Next, the customer passes his/her member card to the operator together with the desired purchase commodity. The operator of the store Al obtains a customer number from the member card through the reader 5 connected with the POS terminal 10 (ACT S6), and then transmits it to the server 20.

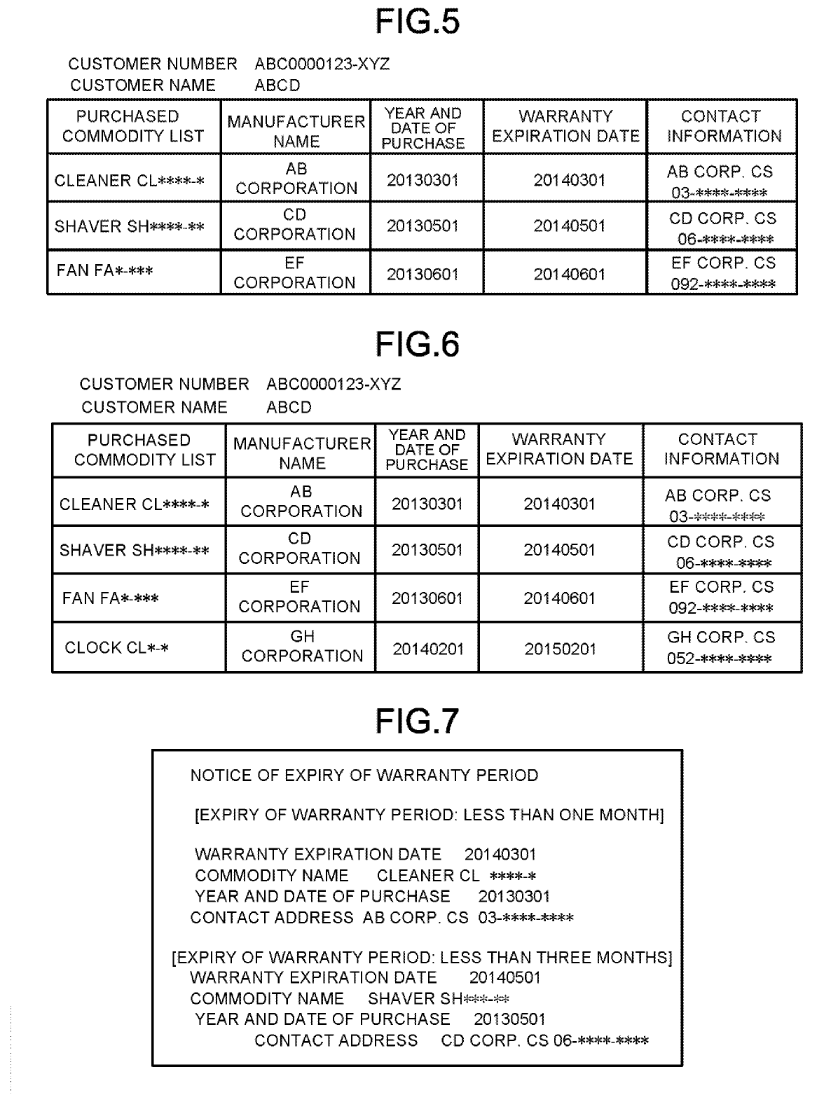

The server 20 includes the customer information management section 22 in which a customer name, a list of commodities purchased in the past by the customer, the purchased commodity-related information and the like (shown as an example in FIG. 5) are stored in association with the customer number. The server 20 extracts corresponding customer information according to the customer number sent thereto (ACT S7), and then stores it in the customer information temporary storage section 23 (ACT S8).

Herein, the customer carries out a settlement with reference to the amount calculated by the purchased amount calculation section 13 (ACT S9). In the present embodiment, it is assumed, for example, that the year and date on which the customer purchases a commodity at this time is Feb. 1, 2014 in the western calendar (A.D.) and the purchased commodity is a clock manufactured by GH Corporation.

The server 20, which receives information indicating completion of the settlement for the commodity from the POS terminal 10, adds information of the commodity purchased, that is recorded in the purchased commodity information temporary storage section 27, to the information stored in the customer information temporary storage section 23 to create the latest customer information shown as an example in FIG. 6 (ACT S10). Then, the created latest customer information is overwritten in the customer information management section 22 (ACT S11).

Next, the warranty period expiry notification target extraction section 25 of the server 20 extracts, according to the extraction conditions stored in the extraction condition storage section 24 beforehand, the purchased commodity having a date meeting the extraction conditions from the warranty expiration date information stored in the purchased information temporary storage section 27. In the present embodiment, it is assumed that the extraction conditions pre-stored in the extraction condition storage section 24 is to extract the commodity of which the expiry of the warranty period is less than one month or the commodity of which the expiry of the warranty period is between one month and three months.

First, the warranty period expiry notification target extraction section 25 confirms, among all the commodities purchased in the past, whether or not there is a commodity of which the expiry of the warranty period is less than one month (ACT S12). If there is a commodity of which the expiry of the warranty period is less than one month (YES in ACT S12), the commodity information of the commodity confirmed is stored in a one-month target commodity temporary storage area (not shown) of the notification information creation section 28 (ACT S13). Further, since the year and date on which the customer purchases a commodity at this time is Feb. 1, 2014 as stated above, the cleaner manufactured by AB Corporation is extracted as the commodity of which the expiry of the warranty period is less than one month.

It is confirmed whether or not there is a commodity of which the expiry of the warranty period is less than one month among all the commodities purchased in the past (ACT S12). Then, if there is no commodity of which the expiry of the warranty period is less than one month (NO in ACT S12), the warranty period expiry notification target extraction section 25 confirms, among all the commodities purchased in the past, whether or not there is a commodity of which the expiry of the warranty period is between one month and three months (ACT S14). If there is also no commodity of which the expiry of the warranty period is between one month and three months (NO in ACT S14), there is no need to give a notification because there is no commodity of which the expiry of the warranty period is approaching at this moment, and then the operation of the warranty expiry prior-notification system 100 is ended.

As described above, it is confirmed whether or not there is a commodity of which the expiry of the warranty period is less than one month among all the commodities purchased in the past (ACT S12) and if there is a commodity of which the expiry of the warranty period is less than one month (YES in ACT S12), the information of the commodity is stored in the one-month target commodity temporary storage area (not shown) of the notification information creation section 28 (ACT S13). Next, as also stated above, the warranty period expiry notification target extraction section 25 confirms, among all the commodities purchased in the past, whether or not there is a commodity of which the expiry of the warranty period is between one month and three months (ACT S16). If there is a commodity of which the expiry of the warranty period is between one month and three months (YES in ACT S16), the information of the commodity is stored in a one to three-month target commodity temporary storage area (not shown) of the notification information creation section 28 (ACT S17). Further, since the year and date on which the customer purchases a commodity at this time is Feb. 1, 2014 as stated above, the shaver manufactured by CD Corporation is extracted as the commodity of which the expiry of the warranty period is between one month and three months.

In ACT S12, if there is no commodity of which the expiry of the warranty period is less than one month (NO in ACT S12), the warranty period expiry notification target extraction section 25 confirms, among all the commodities purchased in the past, whether or not there is a commodity of which the expiry of the warranty period is between one month and three months (ACT S14). If there is a commodity of which the expiry of the warranty period is between one month and three months (YES in ACT S14), similar to that described above, the information of the commodity is stored in the one to three-month target commodity temporary storage area (not shown) of the notification information creation section 28 (ACT S17).

Next, the notification information creation section 28 of the server 20 creates printing data to print the extracted target commodity (ACT S18). Then, the created printing data is transmitted to the approaching warranty expiration date notification section 14 of the POS terminal 10. In the present embodiment, it is assumed, for example, that the notification information creation section 28 has a printing condition in which a commodity of which the expiry of the warranty period is less than one month is printed in bold 12-point font size, and a commodity of which the expiry of the warranty period is between one month and three months is printed in 9-point font size in a normal character.

As stated above, the POS terminal 10 issues a receipt by the printer 4 when the settlement of the purchased commodity is completed. At the time the receipt is issued, a message of the notification information creation section 28 shown as an example in FIG. 7 is transmitted to the printer 4 from the approaching warranty expiration date notification section 14 to print it out (ACT S19), and a sheet on which the message is printed is handed to the customer together with the receipt. Then the current settlement processing is completed (ACT S20). It is exemplified in the present embodiment that the message printed by the approaching warranty expiration date notification section 14 through the printer 4 is issued separate from the receipt. However, the present invention is not limited to this, and for example, the message may be printed at the lower end part of the receipt so that the receipt and the message are suitably arranged on one single paper.

Further, in the description of the present embodiment, the telephone number is named as the contact address of the message. However, the present invention is not limited to this, and a URL of a manufacturer or a URL of a repair department thereof may be recorded. Or, a QR code (registered trademark) may be printed.

Further, in the present embodiment, the warranty period stored in the commodity information storage section 26 is set to one year after the commodity is purchased. However, the present invention is not limited to this, and in a case in which each store provides each extending warranty period more than one year, the warranty period stored in the commodity information storage section 26 may be rewritten.

In this way, every time a commodity is purchased newly, the commodity of which the expiry of the warranty period is approaching is extracted from the commodities purchased in the past and is notified, and therefore, the customer is not required to keep the expiry of the warranty period of each commodity in mind.

Further, since the expiry of the warranty period approaching information of each commodity is provided to the customer at that time the customer purchases a commodity in addition to the receipt of the commodity, it is possible for the customer to obtain the expiry information of warranty even if the customer possesses no terminal (communication tool) capable of receiving mails and the like.

Further, the information only in the case of newly purchasing a commodity is provided in the store, and therefore, it can be expected to increase the sales of commodities.

### A Second Embodiment

Hereinafter, a warranty expiry prior-notification system according to a second embodiment is described.

In the warranty expiry prior-notification system according to the second embodiment, a display section (not shown) is arranged on the POS terminal 10 shown in FIG. 1. A sales commodity purchased in the past of which the expiry of the warranty period is approaching is displayed by the approaching warranty expiration date notification section 14 through the display section.

In addition, the information or message indicating that there is a commodity purchased in the past of which the expiry of the warranty period is approaching is sent from the approaching warranty expiration date notification section 14 to the printer 4 to print it out, and then the printed information or message is handed to the customer together with the receipt. In the stores, there is also a case in which an extending warranty is applied with an additional cost to not a commodity having an original warranty period at the time the commodity is purchased but a commodity of which the expiry of the warranty period is approaching. There may be more customers who hope to receive the extending warranty for the commodity having the original warranty period expiry of which is approaching rather than the commodity having a full original warranty period at the time the commodity is purchased. Thus, the display section is arranged on the POS terminal 10, and information that there is a commodity purchased in the past of which the expiry of the warranty period thereof is approaching is displayed on the display section. The operator is aware of the commodity of which the expiry of the warranty period is approaching, and can offer an extending warranty to the customer. Therefore, a customer satisfaction can be increased.

Further, it is aware that paper on which the information indicating that there is a commodity purchased in the past is printed is output because the information is displayed on the display section and thus the operator can hand the paper to the customer in addition to the receipt.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A warranty expiry prior-notification system, comprising:
a POS terminal, transmitting settlement completion information of a purchased commodity, which includes a data temporary storage section configured to store data of the purchased commodity, a purchased amount calculation section configured to calculate the settlement amount of the purchased commodity, and an approaching warranty expiration date notification section configured to notify that the warranty expiration date of a commodity purchased in the past is approaching; and
a server which includes a customer information management section configured to manage information of a customer containing information of the commodity purchased in the past, a commodity information storage section configured to store information of commodities, a warranty period expiry notification target extraction section configured to extract, according to a predetermined extraction condition, a commodity of which the warranty expiration date is approaching within the commodities purchased by a specified customer in the past, and a notification information creation section configured to create data for outputting information of the commodity that is purchased in the past and extracted by the warranty period expiry notification target extraction section.

2. The warranty expiry prior-notification system according to claim 1, wherein the warranty period expiry notification target extraction section starts to extract, according to the predetermined extraction condition, a commodity of which the warranty expiration date is approaching within the commodities purchased in the past by the specified customer who purchases a commodity when receiving the settlement completion information of the purchased commodity from the POS terminal.

3. The warranty period expiry prior-notification system according to claim 1, wherein the POS terminal further includes a display section, and the approaching warranty expiration date notification section carries out a display notifying that existence of a commodity, purchased by the specified customer in the past, of which the expiry of the warranty period is approaching on the display section.

4. The warranty expiry prior-notification system according to claim 2, wherein the POS terminal further includes a display section, and the approaching warranty expiration date notification section carries-out a display notifying that existence of a commodity, purchased by the specified customer in the past, of which the expiry of the warranty period is approaching on the display section.

5. A POS terminal, which is used in a warranty expiry prior-notification system, comprising:
a code information acquiring section configured to extract a unique code of a commodity attached to the commodity;
a commodity information temporary storage section configured to temporarily store a unique commodity information corresponding to the code extracted by the code information acquiring section from the commodity information storage section in which information of commodities is stored;
a code information acquiring section configured to extract a unique code of a customer who purchases the commodity; and
an approaching warranty expiration date notification section configured to output information of the commodity, purchased by the customer in the past, of which the expiry of the warranty period is approaching, the information of the commodity being extracted according to a predetermined extraction condition from a customer information storage section in which information of customers is stored.

6. The POS terminal according to claim 5, further comprising a display section, wherein the approaching warranty expiration date notification section carries out a display notifying that existence of a commodity, purchased by the customer in the past, of which the expiry of the warranty period is approaching on the display section.

7. A method for prior-notifying an expiry of warranty, including:
first-extracting a unique code of a commodity attached to the commodity purchased by a customer;
second-extracting a unique commodity information corresponding to the unique code extracted in the first-extracting;
third-extracting a unique code of the customer who purchases the commodity;
fourth-extracting information of a commodity, purchased in the past by the customer corresponding to the unique code of the customer extracted in the third-extracting, of which the expiry of the warranty period is approaching according to a predetermined extraction condition; and
outputting the information of the commodity extracted in the fourth-extracting.
